(19) United States
(12) Patent Application Publication
(10) Pub. No.: US 2026/0232024 A1
(43) Pub. Date: Aug. 13, 2026

(54) SUSCEPTOR ARRANGEMENT FOR INDUCTIVELY HEATING AN AEROSOL-FORMING SUBSTRATE

(71) Applicant: Philip Morris Products S.A., Neuchatel (CH)

(72) Inventors: Marco DOTTOR, Fregona (IT); Andreas Michael ROSSOLL, Le Mont-sur-Lausanne (CH); Gérard ZUBER, Boulens (CH); Houxue HUANG, Neuchâtel (CH); Alessio DI GIUSEPPE, Modena (IT)

(73) Assignee: Philip Morris Products S.A., Neuchatel (CH)

(21) Appl. No.: 19/152,553

(22) PCT Filed: Feb. 7, 2024
(86) PCT No.: PCT/EP2024/053065

§ 371 Date: Jul. 31, 2025

(30) Foreign Application Priority Data
Feb. 8, 2023 (EP) 23155604.4

(51) Int. Cl. A24F 40/465; A24D 1/20; A24F 40/20; H05B 6/10

(52) U.S. Cl. CPC A24F 40/465; A24D 1/20; A24F 40/20; H05B 6/105; H05B 2206/023

(57) ABSTRACT

A susceptor arrangement for inductively heating an aerosol-forming substrate is provided, the susceptor arrangement including: at least one susceptor body with a susceptor body surface, the at least one susceptor body including a first susceptor material; and a first heat-spreading layer including a first heat-spreading material, the first heat-spreading layer extending across at least a portion of the susceptor body surface in thermal contact with or in thermal proximity to the portion of the susceptor body surface, and the first heat-spreading material being a non-magnetic metal or a non-magnetic metal alloy that has a thermal conductivity greater than a thermal conductivity of the first susceptor material by at least a factor of 3.5.

The present disclosure relates to a susceptor arrangement for inductively heating an aerosol-forming substrate. The invention further relates to an inductively heatable aerosol-generating article comprising such a susceptor arrangement and to an aerosol-generating device comprising such a susceptor arrangement.

Aerosol-generating articles including at least one aerosol-forming substrate that is capable to form an inhalable aerosol when heated are generally known. For heating the aerosol-forming substrate, the aerosol-generating article may be received within an aerosol-generating device which comprises an electrical heater. The heater may be an inductive heater comprising an induction source. The induction source is configured for generating an alternating magnetic field to inductively heat a susceptor arrangement by at least one of eddy currents and hysteresis losses, depending on the electrical and magnetic properties of the susceptor arrangement. The susceptor arrangement may be integral part of the aerosol-generating article and arranged such as to be in thermal proximity or direct physical contact with the aerosol-generating substrate to be heated. Alternatively, the susceptor arrangement may be part of the aerosol-generating device. In operation of the device, volatile compounds are released from the heated aerosol-forming substrate in the aerosol-generating article and entrained in an airflow that is drawn through the aerosol-generating article during a user's puff. As the released compounds cool down, they condense to form an aerosol.

However, depending on the geometry and the internal structure of the susceptor arrangement, heating of the aerosol-generating substrate may sometimes be unsatisfying. In particular, heating of the substrate may be inhomogeneous, with different temperature regions across the substrate, leading, for example, to inefficiencies in the aerosol generation, inconsistencies in the sensory perception of the aerosol, or the release of undesired volatile compounds.

Therefore, it would be desirable to have a susceptor arrangement with the advantages of prior art solutions, whilst mitigating their limitations. In particular, it would be desirable to achieve a more homogeneous heating of the aerosol-generating substrate.

According to an aspect of the present invention, there is provided a susceptor arrangement for inductively heating an aerosol-forming substrate. The susceptor arrangement comprises at least one susceptor body with a susceptor body surface comprising a first susceptor material, and a first heat-spreading layer comprising a first heat-spreading material. The first heat-spreading layer extends across at least a portion of the susceptor body surface in thermal contact with or in thermal proximity to the portion of the susceptor body surface. The first heat-spreading material further has a thermal conductivity greater than the thermal conductivity of the first susceptor material by at least a factor of 3.5, preferably a factor of 4, more preferred a factor of 5.

Using a susceptor arrangement comprising a heat-spreading layer provides a plurality of advantages as compared to other susceptor arrangements.

The heat-spreading layer improves distribution and dissipation of the generated heat across the surface of the susceptor arrangement, therefore allowing for a more homogenous temperature distribution across the surface of the susceptor arrangement while avoiding temperature hot-spots on the surface of the susceptor arrangement. Hence, heating of the aerosol-generating substrate is improved and a homogenous temperature distribution of the aerosol-generating substrate is achieved.

According to another aspect, there is provided a susceptor arrangement for inductively heating an aerosol-forming substrate. The susceptor arrangement comprises at least one susceptor body with a susceptor body surface comprising a first susceptor material, and a first heat-spreading layer comprising a first heat-spreading material. The first heat-spreading layer extends across at least a portion of the susceptor body surface in thermal contact with or in thermal proximity to the portion of the susceptor body surface. The first susceptor material has a thermal conductivity above 25 W/(m K), in particular above 30 W/(m K), more particularly above 40 W/(m K). For each of these values of the thermal conductivity of the first susceptor material, the first heat-spreading material may have a thermal conductivity greater than the thermal conductivity of the first susceptor material by at least a factor 1.5, preferably a factor of 2, more preferred a factor of 2.5, in particular a factor of 3.

Preferably, the first heat-spreading material may be a carbon allotrope, more preferred graphite or graphene. Carbon allotropes are known for showing high thermal conductivity values and can be provided as a very thin layer, improving the heat characteristics of the susceptor arrangement without substantially increasing the volume and mass of the susceptor arrangement.

Preferably, the first heat-spreading material may be provided as a graphite sheet, more preferred as a pyrolytic graphite sheet. A graphite sheet has the advantage of being flexible and suitable for cutting and can be therefore adapted and/or cut to different shapes of the susceptor arrangement. The graphite sheet is preferably bonded to the susceptor body with a temperature resistant adhesive which may also be non-hazardous when used to heat an aerosol-generating product.

Preferably, the graphite sheet may have a thickness of 1 micrometer to 200 micrometers, more preferred 5 micrometers to 20 micrometers, and even more preferred substantially 10 micrometers.

Alternatively, the first heat-spreading material may be provided as graphene. As such, the graphene may be deposited onto the susceptor body surface by a vapor deposition method, preferably a chemical vapor deposition (CVD) method or a catalyzed chemical vapor deposition (CCVD) method. When provided as graphene, the first heat-spreading material may comprise one graphene layer or several graphene layers.

In yet another alternative, the first heat-spreading material may be a metal. Preferably, the metal is selected from a group comprising: copper, copper alloy, nickel, nickel alloy, aluminum and aluminum alloy.

Preferably, the first heat-spreading layer may have a thickness of 2 micrometers to 100 micrometers, more preferred 3 micrometers to 60 micrometers, even more preferred 5 micrometers to 20 micrometers, in particular 12 micrometers to 16 micrometers. For example, the first heat-spreading layer may have a thickness of 3 micrometers to 30 micrometers or a thickness of 30 micrometers to 60 micrometers.

Preferably, a separator layer may be arranged between the susceptor body and the first heat-spreading layer. The separator layer may preferably comprise at least one of an electrical insulation layer, an anti-diffusion layer, a temperature marker layer with a specific Curie temperature, and a protective layer. A separation layer may be advantageous for providing additional functions to the susceptor arrangement. An electrical insulation layer may be advantageous for avoiding a “skin effect” in the susceptor arrangement, where induced eddy currents at high frequencies tend to flow mainly at the outer surface of the susceptor. In particular, the induced eddy currents tend to flow between the outer surface and a level called the skin depth. By providing an electrical insulation layer between the susceptor body and the first heat spreading layer, the induced eddy currents may be circumscribed to the susceptor body, where they can provide more energy losses and hence more heat.

A temperature marker layer may be advantageous for determining if the susceptor arrangement has reached a predetermined temperature.

For this, the temperature marker layer may comprise a temperature marker material which is magnetic (ferro-or ferrimagnetic) and chosen such as to have a Curie temperature corresponding to a predefined temperature of the susceptor arrangement. At its Curie temperature, the magnetic permeability of the temperature marker material drops, leading to a change of its magnetic properties from ferro- or ferrimagnetic to paramagnetic. The change of the magnetic properties is accompanied by a temporary change of the electrical resistance of the temperature marker layer and therefore of the susceptor arrangement. Thus, by monitoring a corresponding change of the electrical current through the induction source used for heating the susceptor arrangement it can be detected when the temperature marker material has reached its Curie temperature and, thus, when the predefined temperature of the susceptor arrangement has been reached.

A protective layer may be advantageous for providing protection from corrosion. Accordingly, as used herein, the term “protective layer” describes a layer of the susceptor arrangement consisting of or comprising an anti-corrosive material for protecting the material(s) arranged there beneath from corrosion. The anti-corrosive material may be any suitable material resistant to corrosion. The anti-corrosive material may comprise at least one of a corrosion-proof metal, an inert metal, a corrosion-proof alloy, a corrosion-proof organic coating, a glass, a ceramic, a polymer, an anti-corrosion paint, a wax or a grease.

An anti-diffusion layer may be advantageous for providing a barrier between the susceptor body and the first heat-spreading layer, e.g. preventing diffusion of ions and an undesired build-up of electrical potential within the susceptor arrangement. Accordingly, as used herein, the term “anti-diffusion layer” describes a layer of the susceptor arrangement consisting of or comprising an anti-diffusion material acting as a barrier avoiding material diffusion from and/or to material(s) of the susceptor arrangement arranged there below. For example, the anti-diffusion layer may be configured to avoid metal migration from the materials of the susceptor arrangement into the aerosol-forming substrate or to avoid metal migration between different layers of the susceptor arrangement. As an example, the anti-diffusion layer may have a thickness of 6 micrometers and may comprise or consist of nickel or a nickel alloy. This is in particular advantageous when a metallic heat-spreading layer is used, for example copper or a copper alloy, which may have a thickness between 12 micrometers and 16 micrometers, to avoid diffusion of ions of the heat-spreading layer into the susceptor body. In this example, the susceptor body may be preferably comprise or consist of an AISI 430 steel susceptor material and may be up to 60 micrometers thick.

On a side opposite to the susceptor arrangement, the first heat-spreading layer may be additionally or alternatively at least partially coated with at least one of an electrical insulation layer, an anti-diffusion layer, a temperature marker layer with a specific Curie temperature, and a protective layer. The electrical insulation layer, the anti-diffusion layer, the temperature marker layer and the protective layer may have the same functions and properties as the respective layer described above with respect to the separation layer.

Preferably, the susceptor body is a substantially flat element and the susceptor body surface comprises a first susceptor body main surface and an opposite second susceptor body main surface. This has the advantage that a precursor of the susceptor body may be provided as a strip or sheet, and the susceptor body may be cut off the strip or sheet with the desired shape and dimensions. Alternatively, a susceptor arrangement precursor may be provided as a strip or sheet, and the susceptor arrangement may be cut off the strip or sheet with the desired shape and dimensions. Of course, intermediate products of the susceptor arrangement may be also provided as a strip-like or sheet like precursor.

Preferably, the first heat-spreading layer may extend across at least a portion of at least one of the first susceptor body main surface and the second susceptor body main surface.

Alternatively, the first heat-spreading layer may extend across at least a portion of the first susceptor body main surface, and the susceptor arrangement may further comprise a second heat-spreading layer comprising a second heat-spreading material, wherein the second heat-spreading layer may extend across at least a portion of the second susceptor body main surface in thermal contact with or in thermal proximity to the portion of the second susceptor body main surface. This is advantageous in that at least a portion of both, the first and the second susceptor body main surfaces, are provided with a first and a second heat-spreading layer, respectively, therefore providing the advantages of the heat-spreading layer on both opposite sides of the susceptor arrangement.

Preferably, the first heat spreading layer extends across the whole first susceptor body main surface and/or the second heat spreading layer extends across the whole second susceptor body main surface.

Preferably, the first heat-spreading layer and the second heat-spreading layer may be identical in at least one of the following characteristics: a heat-spreading material, a thickness of the heat-spreading layer, a width of the heat-spreading layer, a length of the heat-spreading layer, an area of the heat-spreading layer.

As used herein, the term “width” of the heat-spreading layer, when the susceptor body is provided as a substantially flat element, describes the dimension of the heat-spreading layer extending along a first of its main axis. Analogously, the term “length” describes the dimension of the heat-spreading layer extending along its second main axis perpendicular to the first axis. The term “area”, finally, describes the dimension of a surface of the heat-spreading layer extending along a given width and a given length.

Preferably, the susceptor body may be a multi-layer susceptor body. The multi-layer susceptor body may comprise at least two layers, in particular two layers, or three layers or four layers.

The susceptor body may preferably comprise a layer made of the first susceptor material and a temperature marker layer with a specific Curie temperature. The layer made of the first susceptor material and the temperature marker layer may be adjacent layers. In addition, the susceptor body may further comprise a protective layer. The protective layer may be preferably arranged on top of the temperature marker layer opposite to the layer made of the first susceptor material. The layer made of the first susceptor material and the temperature marker layer may be intimately coupled to each other. Likewise, if present, the protective layer and the temperature marker layer may be intimately coupled to each other. For example, one of the respective layers may be plated, deposited, coated, cladded or welded onto a respective other one of the layers. Likewise, one of the respective layers may be applied onto a respective other one of the layers by spraying, dip coating, roll coating, electroplating or cladding.by spraying, dip coating, roll coating, electroplating or cladding. Any of the configurations described above falls within the term “intimately coupled” as used herein.

The susceptor body may be, in an alternative configuration, rod-shaped, with the susceptor body surface being the shell surface of the rod-shaped susceptor body. As for the configuration with the susceptor body being provided as a substantially flat element, a precursor of the rod-shaped susceptor body may be provided as a filament or strip and the rod-shaped successor body may be cut off the filament or strip with the desired dimensions. Of course, the susceptor arrangement or intermediate products thereof may be analogously provided as filament-like or strip-like precursor and processed accordingly.

The susceptor body may also comprise at least one fiber or thread, and more preferred, the susceptor body or the susceptor arrangement may be provided as one of a wick, a fleece, a mesh or a fabric. These alternative configurations are particularly advantageous when the aerosol-forming substrate is provided as a liquid substrate or a gel-like substrate, wherein the susceptor body or the susceptor arrangement being provided as one of a wick, a fleece, a mesh or a fabric may be used not only to heat the aerosol-forming substrate but also to store and/or convey the aerosol-forming substrate due to the capillary properties of the wick, fleece, mesh or fabric. The susceptor body may be provided as a fiber, fiber bundle or thread, the first heat-spreading layer may be then provided to the susceptor body and a wick, fleece, mesh or fabric may then be fabricated out of the susceptor body comprising the first heat-spreading layer. Alternatively, the susceptor body is already provided as one of a wick, a fleece, a mesh or a fabric and the first heat-spreading layer may then be provided to the susceptor body. Intermediate forms may also be possible. As an example, a fiber comprising a first susceptor material, a temperature marker layer with a specific Curie temperature and a protective layer is provided. Then, the fiber may be used to fabricate a susceptor body mesh, and the first heat-spreading layer may be then provided to the susceptor body mesh.

Alternatively, the susceptor body or the susceptor arrangement may be a mesh. The difference from the above cited configuration is that in this preferred configuration, the susceptor body does not comprise a fiber or thread, but is monolithically formed as a mesh. As an example, the susceptor body may be provided as a multi-layer sheet and then perforated to form a mesh, and the heat-spreading layer then provided to the mesh. Or the susceptor arrangement may be provided as a multi-layer sheet and then perforated to form a mesh.

Preferably, the susceptor body may be a bead and the susceptor body surface a bead outer surface. The susceptor body may be therefore provided as a bulk material with an in particular spherical shape. An advantage of the susceptor body being a bead is that the susceptor arrangement may be spread or dispersed in an aerosol-forming substrate, therefore providing a more homogeneous heating of the aerosol-forming substrate as compared to configurations with a substantially flat or rod-shaped susceptor arrangement.

Preferably, the first and/or the second heat-spreading material may have a thermal conductivity greater than 80 W/(m K), in particular greater than 100 W/(m K), more particularly greater than 200 W/(m K), preferably greater than 350 W/(m K), more preferred greater than 1000 W/(m K) at 25 degrees Celsius.

According to another aspect of the present invention, there is provided an inductively heatable aerosol-generating article comprising an aerosol-forming substrate and at least one susceptor arrangement as described herein. All the preferred configurations and advantages related to those preferred configurations, as described above, can be applied accordingly to the inductively heatable aerosol-generating article.

As used herein, the term “aerosol-generating article” refers to an article comprising at least one aerosol-forming substrate capable of releasing volatile compounds when heated which can form an aerosol. Preferably, the aerosol-generating article is a heated aerosol-generating article. That is, an aerosol-generating article which comprises at least one aerosol-forming substrate that is intended to be heated rather than combusted. The aerosol-generating article may be a consumable, in particular a consumable to be discarded after a single use. For example, the article may be a cartridge including a liquid aerosol-forming substrate to be heated. As another example, the article may be a rod-shaped article, in particular a tobacco article, resembling conventional cigarettes.

As used herein, the term “aerosol-forming substrate” denotes a substrate formed from or comprising an aerosol-forming material that is capable of releasing volatile compounds upon heating in order to generate an aerosol. Preferably, the aerosol-forming substrate is intended to be heated rather than combusted in order to release the aerosol-forming volatile compounds. The aerosol-forming substrate may be a solid aerosol-forming substrate, a liquid aerosol-forming substrate, gel-like aerosol-forming substrate, or any combination thereof. For example, the aerosol-forming substrate may comprise both solid and liquid components. The aerosol-forming substrate may comprise a tobacco-containing material containing volatile tobacco flavor compounds, which are released from the substrate upon heating. Alternatively or additionally, the aerosol-forming substrate may comprise a non-tobacco material. The aerosol-forming substrate may further comprise an aerosol former. Examples of suitable aerosol formers are glycerin and propylene glycol. The aerosol-forming substrate may also comprise other additives and ingredients, such as nicotine or flavourants. The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

Preferably, the article may be an elongate article or a rod-shaped article. The elongate or rod-shaped article may have a shape resembling the shape of conventional cigarettes.

The aerosol-generating article, in particular the elongate or rod-shaped article, may have a circular or elliptical or oval or square or rectangular or triangular or a polygonal cross-section.

As an example, the aerosol-generating article may be a rod-shaped article, in particular a cylindrical article comprising one or more of the following elements: a distal front plug element, a substrate element, a first tube element, a second tube element, and a filter element.

The substrate element preferably comprises the at least one aerosol-forming substrate to be heated and the susceptor arrangement in thermal contact with or thermal proximity to the aerosol-forming substrate. The substrate element may have a length of 10 millimeters to 14 millimeters, for example, 12 millimeters.

The first tube element is more distal than the second tube element. Preferably, the first tube element is proximal of the substrate element, whereas the second tube element is proximal of the first tube element and distal of the filter element, that is, between the first tube element and the filter element. At least one of the first tube element and the second tube element may comprise a central air passage. A cross-section of the central air passage of the second tube element may be larger than a cross-section of the central air passage of the first tube element. Preferably, at least one of the first tube element and the second tube element may comprise a hollow cellulose acetate tube. At least one of the first tube element and the second tube element may have a length of 6 millimeters to 10 millimeters, for example, 8 millimeters.

The filter element preferably serves as a mouthpiece, or as part of a mouthpiece together with the second tube element. As used herein, the term “mouthpiece” refers to a portion of the article through which the aerosol exits the aerosol-generating article. The filter element may have a length of 10 millimeters to 14 millimeters, for example, 12 millimeters.

The distal front plug element may be used to cover and protect the distal front end of the substrate element. The distal front plug element may have a length of 3 millimeters to 6 millimeters, for example, 5 millimeters. The distal front plug element may be made of the same material as the filter element

All of the aforementioned elements may be sequentially arranged along a length axis of the article in the above described order, wherein the distal front plug element preferably is arranged at a distal end of the article and the filter element preferably is arranged at a proximal end of the article. Each of the aforementioned elements may be substantially cylindrical. In particular, all elements may have the same outer cross-sectional shape and/or dimensions. In addition, the elements may be circumscribed by one or more outer wrappers such as to keep the elements together and to maintain the desired cross-sectional shape of the rod-shaped article. Preferably, the wrapper is made of paper. The wrapper may further comprise adhesive that adheres the overlapped free ends of the wrapper to each other. For example, the distal front plug element, the substrate element and the first tube element may be circumscribed by a first wrapper, and the second tube element and the filter element may be circumscribed by a second wrapper. The second wrapper may also circumscribe at least a portion of the first tube element (after being wrapped by the first wrapper) to connect the distal front plug element, the substrate element and the first tube element being circumscribed by a first wrapper to the second tube element and the filter element. The second wrapper may comprise perforations around its circumference.

According to another aspect of the present invention there is provided an aerosol-generating device for heating an aerosol-generating article comprising an aerosol-forming substrate, the aerosol-generating device comprising at least one susceptor arrangement as described herein. All the preferred configurations and advantages related to those preferred configurations, as described above, can be applied accordingly to the aerosol-generating device.

As used herein, the term “aerosol-generating device” may describe an electrically operated device for interaction with an aerosol-generating article comprising an aerosol-forming substrate in order to generate an aerosol by inductively heating the aerosol-forming substrate via the susceptor arrangement of the device. Preferably, the aerosol-generating device is a puffing device for generating an aerosol that is directly inhalable by a user through the user's mouth. In particular, the aerosol-generating device is a hand-held aerosol-generating device.

The device may comprise a receiving cavity for removably receiving at least a portion of the aerosol-generating article.

The aerosol-generating device comprises an inductive heating arrangement configured and arranged to generate an alternating magnetic field capable to inductively heat the susceptor arrangement of the device.

For generating the alternating magnetic field, the inductive heating arrangement may comprise at least one induction coil surrounding at least a portion of the susceptor arrangement. The at least one induction coil may be a helical coil or flat planar coil, in particular a pancake coil or a curved planar coil.

The inductive heating arrangement may further comprise an alternating current (AC) generator. The AC generator may be powered by a power supply of the aerosol-generating device. The AC generator is operatively coupled to the at least one induction coil. In particular, the at least one induction coil may be integral part of the AC generator. The AC generator is configured to generate a high frequency oscillating current to be passed through the at least one induction coil for generating an alternating magnetic field. The AC current may be supplied to the at least one induction coil continuously following activation of the system or may be supplied intermittently, such as on a puff by puff basis. Preferably, the inductive heating arrangement comprises a DC/AC converter including an LC network, wherein the LC network comprises a series connection of a capacitor and the inductor. The DC/AC converter may be connected to a DC power supply.

The inductive heating arrangement preferably is configured to generate a high-frequency magnetic field. As referred to herein, the high-frequency magnetic field may be an alternating magnetic field with a frequency in a range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

The aerosol-generating device may further comprise a controller configured to control operation of the heating process, preferably in a closed-loop configuration, in particular for controlling heating of the aerosol-forming liquid to a pre-determined operating temperature.

The controller may be or may be art of an overall controller of the aerosol-generating device.

The controller may comprise a microprocessor, for example a programmable microprocessor, a microcontroller, or an application specific integrated chip (ASIC) or other electronic circuitry capable of providing control. The controller may comprise further electronic components, such as at least one DC/AC inverter and/or power amplifiers, for example a Class-C power amplifier or a Class-D power amplifier or Class-E power amplifier. In particular, the induction source may be part of the controller.

The aerosol-generating device may also comprise a power supply, in particular a DC power supply configured to provide a DC supply voltage and a DC supply current to the induction source.

Preferably, the power supply is a battery such as a lithium iron phosphate battery. The power supply may be rechargeable. The power supply may have a capacity that allows for the storage of enough energy for one or more user experiences. For example, the power supply may have sufficient capacity to allow for the continuous generation of aerosol for a period of around six minutes or for a period that is a multiple of six minutes. In another example, the power supply may have sufficient capacity to allow for a predetermined number of puffs or discrete activations of the induction source.

The invention is defined in the claims. However, below there is provided a non-exhaustive list of non-limiting examples. Any one or more of the features of these examples may be combined with any one or more features of another example, embodiment, or aspect described herein.

Example Ex1: A susceptor arrangement for inductively heating an aerosol-forming substrate, the susceptor arrangement comprising at least one susceptor body with a susceptor body surface, the susceptor body comprising a first susceptor material; and a first heat-spreading layer comprising a first heat-spreading material, wherein the first heat-spreading layer extends across at least a portion of the susceptor body surface in thermal contact with or in thermal proximity to the portion of the susceptor body surface, and wherein the first heat-spreading material has a thermal conductivity greater than the thermal conductivity of the first susceptor material by at least a factor of 3.5, preferably a factor of 4, more preferred a factor of 5.

Example Ex2: The susceptor arrangement according to example Ex1, wherein the first heat-spreading material is a carbon allotrope, preferably graphite or graphene.

Example Ex3: The susceptor arrangement according to examples Ex1 or Ex2, wherein the first heat-spreading material is provided as a graphite sheet, preferably a pyrolytic graphite sheet.

Example Ex4: The susceptor arrangement according to example Ex3, wherein the graphite sheet has a thickness of 1 micrometer to 200 micrometers, preferably 5 micrometers to 20 micrometers, more preferred substantially 10 micrometers.

Example Ex5: The susceptor arrangement according to example Ex1, wherein the first heat-spreading material is a metal.

Example Ex6: The susceptor arrangement according to example Ex5, wherein the metal is selected from a group comprising: copper, a copper alloy, nickel, a nickel alloy, aluminum, an aluminum alloy.

Example Ex7: The susceptor arrangement according to example Ex5 or Ex6, wherein the first heat-spreading layer has with a thickness of 2 micrometers to 100 micrometers, preferably 3 micrometers to 60 micrometer, more preferably 5 micrometers to 20 micrometers, more preferred 12 micrometers to 16 micrometers, for example 3 micrometers to 30 micrometers or 30 micrometers to 60 micrometers.

Example Ex8: The susceptor arrangement according to any one of the preceding examples Ex1 to Ex7, wherein a separator layer is arranged between the susceptor body and the first heat-spreading layer.

Example Ex9: The susceptor arrangement according to example Ex8, wherein the separator layer comprises at least one of an electrical insulation layer, an anti-diffusion layer, a temperature marker layer with a specific Curie temperature, and a protective layer.

Example Ex10: The susceptor arrangement according to any one of the preceding examples Ex1 to Ex9, wherein the first heat-spreading layer is at least partially coated with at least one of an electrical insulation layer, an anti-diffusion layer, a temperature marker layer with a specific Curie temperature, and a protective layer.

Example Ex11: The susceptor arrangement according to any one of the preceding examples Ex1 to Ex10, wherein the susceptor body is a substantially flat element and the susceptor body surface comprises a first susceptor body main surface and an opposite second susceptor body main surface.

Example Ex12: The susceptor arrangement according to example Ex11, wherein the first heat-spreading layer extends across at least a portion of at least one of the first susceptor body main surface and the second susceptor body main surface.

Example Ex13: The susceptor arrangement according to example Ex11, wherein the first heat-spreading layer extends across at least a portion of the first susceptor body main surface, the susceptor arrangement further comprising a second heat-spreading layer comprising a second heat-spreading material, wherein the second heat-spreading layer extends across at least a portion of the second susceptor body main surface in thermal contact with or in thermal proximity to the portion of the second susceptor body main surface.

Example Ex14: The susceptor arrangement according to example Ex13, wherein the first heat spreading layer extends across the whole first susceptor body main surface and/or the second heat spreading layer extends across the whole second susceptor body main surface.

Example Ex15: The susceptor arrangement according to example Ex13 or Ex14, wherein the first heat-spreading layer and the second heat-spreading layer are identical in at least one of the following characteristics: a heat-spreading material, a thickness of the heat-spreading layer, a width of the heat-spreading layer, a length of the heat-spreading layer, an area of the heat-spreading layer.

Example Ex16: The susceptor arrangement according to any one of examples Ex11 to Ex15, wherein the susceptor body is a multi-layer susceptor body.

Example Ex17: The susceptor arrangement according to example Ex16, wherein the susceptor body comprises at least two layers.

Example Ex18: The susceptor arrangement according to example Ex17, wherein the susceptor body comprises a layer made of the first susceptor material and a temperature marker layer with a specific Curie temperature.

Example Ex19: The susceptor arrangement according to example Ex18, wherein the susceptor body further comprises a protective layer, preferably intimately coupled to the temperature marker layer.

Example Ex20: The susceptor arrangement according to any one of examples Ex1 to Ex10, wherein the susceptor body is rod-shaped and the susceptor body surface is the shell surface of the rod-shaped susceptor body.

Example Ex21: The susceptor arrangement according to any one of examples Ex1 to Ex10, wherein the susceptor body comprises at least one fiber or thread.

Example Ex22: The susceptor arrangement according to example Ex21, wherein the susceptor body or the susceptor arrangement is provided as one of a wick, a fleece, a mesh or a fabric.

Example Ex23: The susceptor arrangement according to any one of examples Ex1 to Ex10, wherein the susceptor body or the susceptor arrangement is a mesh.

Example Ex24: The susceptor arrangement according to any one of examples Ex1 to Ex10, wherein the susceptor body is a bead and the susceptor body surface is a bead outer surface.

Example Ex25: The susceptor arrangement according to any one of examples Ex1 to Ex24, wherein the first and/or second heat-spreading material has a thermal conductivity greater than 80 W/(m K), in particular greater than 100 W/(m K), more particularly greater than 200 W/(m K), preferably greater than 350 W/(m K), more preferred greater than 1000 W/(m K).

Example Ex26: An inductively heatable aerosol-generating article comprising an aerosol-forming substrate and at least one susceptor arrangement according to any one of examples Ex1 to Ex 25.

Example Ex27: An aerosol-generating device for heating an aerosol-generating article comprising an aerosol-forming substrate, the aerosol-generating device comprising at least one susceptor arrangement according to any one of examples Ex1 to Ex25.

Examples will now be further described with reference to the figures in which:

FIG. 1A shows schematically possible configurations of a susceptor body without a heat-spreading layer;

FIGS. 1B-C show schematically possible configurations of a susceptor body and heat-spreading layers according to the present invention;

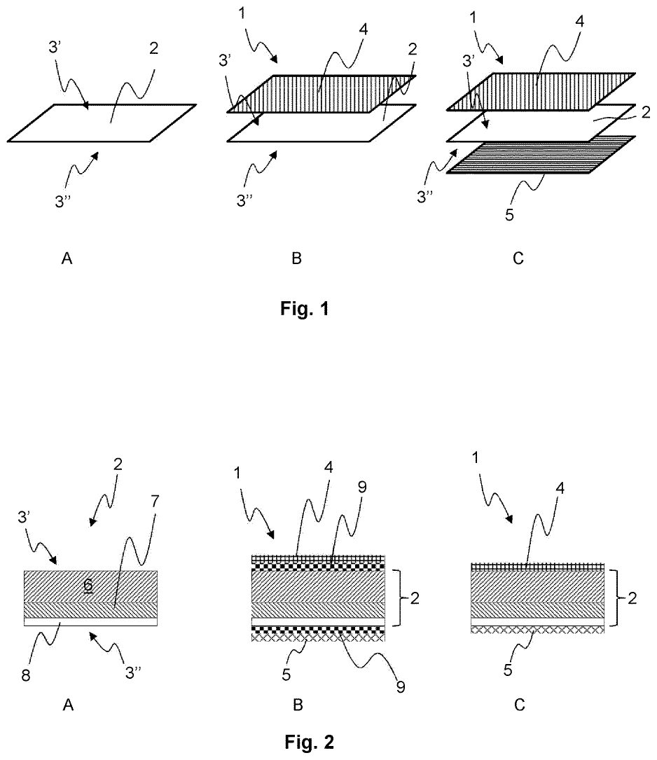

FIG. 2A shows schematically a possible configuration of a susceptor body without a heat-spreading layer;

FIGS. 2B-C show schematically different possible layer configurations of a susceptor arrangement according to the present invention;

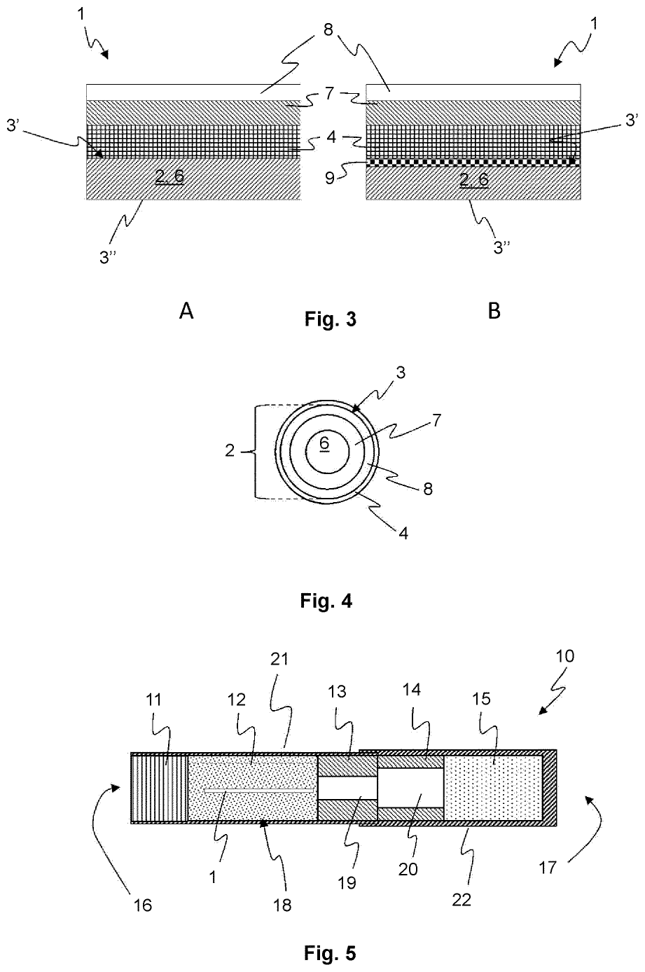

FIGS. 3A-B show in schematic sectional views further possible layer configurations of a susceptor arrangement according to the present invention;

FIG. 4 shows a schematic a cross section through a rod-shaped susceptor arrangement according to the present invention;

FIG. 5 shows schematically an inductively heatable aerosol-generating article comprising a susceptor arrangement according to the present invention;

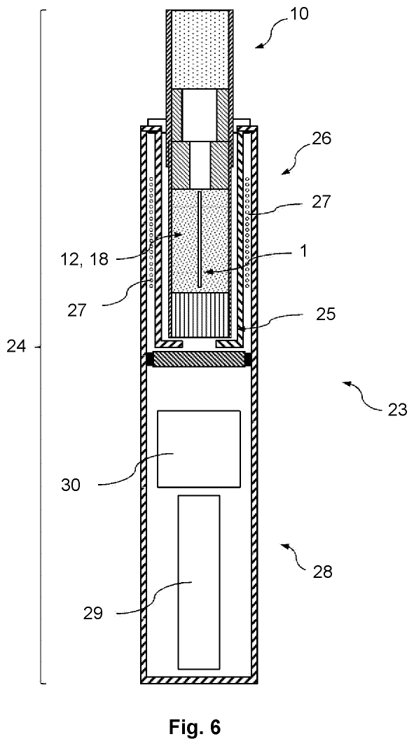

FIG. 6 shows schematically an aerosol-generating device comprising an aerosol-generating article according to the present invention;

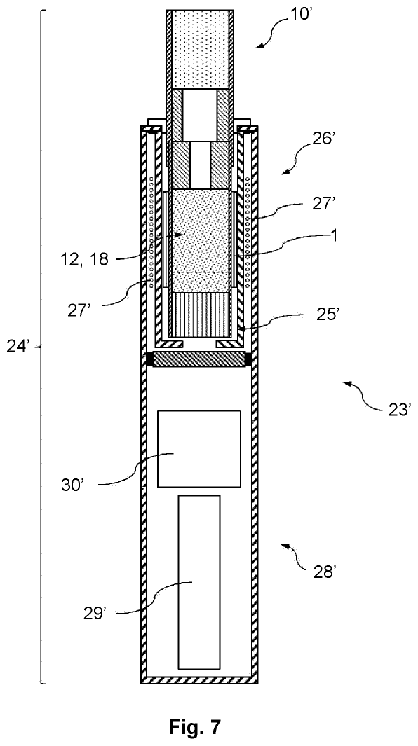

FIG. 7 shows schematically an aerosol-generating device comprising a susceptor arrangement according to the present invention; and

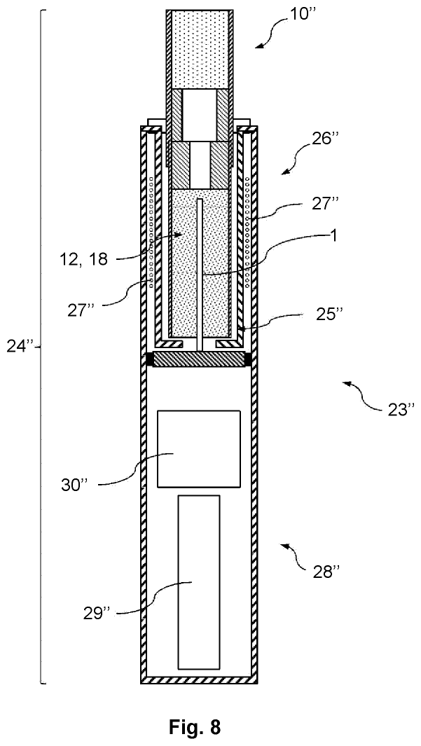

FIG. 8 shows schematically another embodiment of an aerosol-generating device comprising a susceptor arrangement according to the present invention.

In FIG. 1A, a susceptor body 2 provided as a substantially flat element is shown. The susceptor body 2 has a susceptor body surface 3, wherein in the configuration shown in FIG. 1A, a susceptor body surface 3 comprises a first susceptor body main surface 3′ and a second susceptor body main surface 3″ opposite to the first susceptor body main surface 3′.

In FIG. 1B, a susceptor arrangement comprising a susceptor body 2 as shown in FIG. 1A and a first heat-spreading layer 4 is illustrated. The first heat-spreading layer 4 is in thermal contact with or in thermal proximity to the first susceptor body main surface 3′ and substantially extends across the whole first susceptor body main surface 3′. In contrast, the second susceptor body main surface 3″ opposite to the first susceptor body main surface 3′ is not covered by any layer, in particular a heat-spreading layer, but is exposed.

In FIG. 1C, the susceptor arrangement 1 comprises a first heat-spreading layer 4 and a second heat-spreading layer 5. The first heat-spreading layer 4 is in thermal contact with or in thermal proximity to the first susceptor body main surface 3′ and substantially extends across the whole first susceptor body main surface 3′, wherein the second heat-spreading layer 5 is in thermal contact with or in thermal proximity to the second susceptor body main surface 3″ and substantially extends across the whole second susceptor body main surface 3″. The first heat-spreading layer 4 and/or the second heat spreading layer 5 improves distribution and dissipation of the generated heat across the surface of the susceptor arrangement 1, therefore allowing for a more homogenous temperature distribution across the surface of the susceptor arrangement 1 while avoiding temperature hot-spots on the surface of the susceptor arrangement 1. Hence, heating of an aerosol-generating substrate is improved and a homogenous temperature distribution of the aerosol-generating substrate is achieved.

In FIG. 2A, another possible configuration of the susceptor body 2 is depicted in cross-section. The susceptor body 2 is a multi-layer susceptor body comprising a layer made of a first susceptor material 6, which is intimately coupled to a temperature marker layer 7. The susceptor body 2 also comprises a protective layer 8, which is intimately coupled to the temperature marker layer 7 opposite to the layer made of a first susceptor material 6. The first susceptor body main surface 3′ is an outer surface of the layer made of the first susceptor material 6, while the second susceptor body main surface 3″ is an outer surface of the protective layer 8. The first susceptor material 6 is steel, in particular AISI 430 steel, and has a thickness of 40.5 micrometers. The temperature marker layer 7 is made of FeNi80Mo alloy, and has a thickness of 16.5 micrometers. The protective layer 8 is made of steel, in particular AISI 430 steel, and has a thickness of 3 micrometers. In an alternative configuration, the temperature marker layer 7 is made of FeNi80Mo alloy, and has a thickness of 16 micrometers, while the protective layer 8 is made of steel, in particular AISI 430 steel, and has a thickness of 3.5 micrometers.

FIGS. 2B and 2C show another possible configuration of the susceptor arrangement 1. The susceptor body 2 is shown with the same configuration of the susceptor body 2 of FIG. 2A for sake of simplicity only. The first susceptor body main surface 3′ and the second susceptor body main surface 3″ are provided with a first heat-spreading layer 4 and a second heat-spreading layer 5, respectively. The first heat-spreading layer 4 and the second heat-spreading layer 5 comprise a first heat-spreading material and a second heat-spreading material, respectively.

In the configuration of FIG. 2C, the first heat-spreading layer 4 and the second heat-spreading layer 5 are in thermal contact with the susceptor body 2, while in the configuration of FIG. 2B, a separation layer 9 is interposed between the susceptor body 2 and the first heat-spreading layer 4 and between the susceptor body 2 and the second heat-spreading layer 5, respectively. Each of the two separation layers 9 is an electrical insulator layer with a thickness of 5 micrometers. The first heat-spreading material and/or the second heat-spreading material may be a carbon allotrope such as graphite. The first heat-spreading layer 4 and the second heat-spreading layer 5 may each have a thickness of 10 micrometers. The graphite is preferably provided as a graphite sheet and is bonded to the susceptor body 2, as shown in FIG. 2C, or to the respective separation layer 9, as shown in FIG. 2B, by means of an adhesive.

Alternatively, the first heat-spreading material and/or the second heat-spreading material may be another carbon allotrope, such as graphene. The graphene may be deposited onto the susceptor body 2, as shown in FIG. 2C, or onto the separation layer 9, as shown in FIG. 2B, by a vapor deposition method, preferably a chemical vapor deposition (CVD) method or a catalyzed chemical vapor deposition (CCVD) method. The first heat-spreading layer 4 and/or the second heat-spreading layer 5 may each comprise one graphene layer or several graphene layers.

In another alternative configuration, the first heat-spreading material and/or the second heat-spreading material is a metal or metal alloy.

Another possible configuration of a susceptor arrangement 1 is shown in FIG. 3A. The susceptor arrangement 1 comprises a susceptor body 2 which comprises a first susceptor material 6 with a first susceptor body main surface 3′ and a second susceptor body main surface 3″. The first susceptor material 6 is steel, in particular AISI 430 steel. The susceptor body 2 may have a thickness of up to 60 micrometers. A first heat-spreading layer 4 is in thermal contact with to the first susceptor body main surface 3′ and has a thickness between 12 micrometers and 16 micrometers. The first heat-spreading layer 4 is intimately coupled to the susceptor body 2 and comprises at least a first heat-spreading material, preferably a carbon allotrope or a metal, as described above. Alternatively, as shown in FIG. 3B, a separation layer 9 is arranged between the susceptor body 2 and the first heat-spreading layer 4. The separation layer 9 is made of an anti-diffusion material and has a thickness of 6 micrometer. The susceptor arrangement 1 further comprises a temperature marker layer 7, which is intimately coupled to the first heat-spreading layer 4 opposite to the susceptor body 2. The temperature marker layer 7 is made of FeNi80Mo alloy, and has a thickness between 6 micrometers and 8 micrometers. Further, the susceptor arrangement 1 comprises a protective layer 8, which is intimately coupled to the temperature marker layer 7. The protective layer 8 is made of steel, in particular AISI 430 steel, and has a thickness of 3.5 micrometers.

FIG. 4 shows schematically a cross section through a rod-shaped susceptor arrangement 1. The rod-shaped susceptor arrangement 1 comprises a multi-layer rod-shaped susceptor body 2 with a susceptor body surface 3, which is the shell surface of the rod-shaped susceptor body 2. The multi-layer rod-shaped susceptor body 2 comprises a core comprising a first susceptor material 6. On top, the rod-shaped susceptor body 2 further comprises a temperature marker layer 7, which is intimately coupled to the core comprising the first susceptor material 6. On top of the temperature marker layer 7, the rod-shaped susceptor body 2 further comprises a protective layer 8, which is intimately coupled to the temperature marker layer 7. Further, the susceptor arrangement 1 comprise a first heat-spreading layer 4, which is intimately coupled to the susceptor body 2, in this configuration to the protective layer 8 of the susceptor body 2 which forms the susceptor body surface 3.

It should be self-explaining that in the case of a rod-shaped susceptor arrangement 1, the above described configuration is purely exemplary and other configurations as explained above with respect to the susceptor body 2 being provided as a substantially flat element may be implemented.

FIG. 5 shows schematically an inductively heatable aerosol-generating article 10 comprising a susceptor arrangement 1 according to the present invention (not to scale). The aerosol-generating article 10 is a substantially rod-shaped consumable comprising five elements sequentially arranged in coaxial alignment: a distal front plug element 11, a substrate element 12, a first tube element 13, a second tube element 14, and a filter element 15. The distal front plug element 11 is arranged at a distal end 16 of the aerosol-generating article 10 to cover and protect the distal front end of the substrate element 12, whereas the filter element 15 is arranged at a proximal end 17 of the aerosol-generating article 10. Both the distal front plug element 11 and the filter element 15 may be made of the same filter material. The filter element 15 preferably serves as a mouthpiece, preferably as part of a mouthpiece together with the second tube element 14.

The filter element 15 may have a length of 10 millimeters to 14 millimeters, for example, 12 millimeters, whereas the distal front plug element 11 may have a length of 3 millimeters to 6 millimeters, for example, 5 millimeters. The substrate element 12 comprises an aerosol-forming substrate 18 to be heated as well as a susceptor arrangement 1 according to the present invention, for example as shown in FIG. 1B, 1C; 2B, 2C, 3A or 3B, that is configured and arranged to heat the aerosol forming substrate 18. For this, the susceptor arrangement 1 is fully embedded in the aerosol forming substrate 18 such as to be in direct thermal contact with the aerosol forming substrate 18. The substrate element 12 may have a length of 10 millimeters to 14 millimeters, for example, 12 millimeters. Each one of the first and the second tube element 13, 14 is a hollow cellulose acetate tube having a central air passage 19, 20, wherein a cross-section of the central air passage 20 of the second tube element 14 is larger than a cross-section of the central air passage 19 of the first tube element 13. The first and second tube element 13, 14 may have a length of 6 millimeters to 10 millimeters, for example, 8 millimeters.

In use, an aerosol formed by volatile compounds released from the substrate element 12 upon heating is drawn through the first and second tube element 13, 14 and the filter element 15 towards the proximal end 17 of the aerosol-generating article 10. Each of the aforementioned elements 11, 12, 13, 14, 15 may be substantially cylindrical. In particular, all elements 11, 12, 13, 14, 15 may have the same outer cross-sectional shape and dimensions.

In addition, the elements may be circumscribed by one or more outer wrappers such as to keep the elements together and to maintain the desired cross-sectional shape of the rod-shaped article. The distal front plug element 11, the substrate element 12 and the first tube element 13 are circumscribed by a first wrapper 21, whereas the second tube element 14 and the filter element 15 are circumscribed by a second wrapper 22. The second wrapper 22 also circumscribes at least a portion of the first tube element 13 (after being wrapped by the first wrapper 21) to connect the distal front plug element 11, the substrate element 12 and the first tube element 13 being circumscribed by the first wrapper 21 to the second tube element 14 and the filter element 15. Preferably, the first and the second wrapper 21, 22 are made of paper. In addition, the second wrapper 22 may comprise perforations around its circumference (not shown). The wrappers 21, 22 may further comprise adhesive that adheres the overlapped free ends of the wrappers to each other.

As shown in FIG. 6, the aerosol-generating article 10 according to FIG. 5 is configured for use with an inductively heating aerosol-generating device 23. Together, the aerosol-generating device 23 and the aerosol-generating article 10 form an aerosol-generating system 24. The aerosol-generating device 23 comprises a cylindrical receiving cavity 25 defined within a proximal portion 26 of the aerosol-generating device 23 for receiving a least a distal portion of the aerosol-generating article 10 therein. The aerosol-generating device 23 further comprises an inductive heating arrangement including an induction coil 27 for generating an alternating, in particular high-frequency magnetic field within the cylindrical receiving cavity 25. The induction coil 27 is a helical coil circumferentially surrounding the cylindrical receiving cavity 25. The induction coil 27 is arranged such that the susceptor arrangement 1 of the aerosol-generating article 10 is exposed to a magnetic field upon inserting the aerosol-generating article 10 into the cylindrical receiving cavity 25 of the aerosol-generating device 23. Thus, when activating the inductive heating arrangement, the susceptor arrangement 1 heats up due to eddy currents and/or hysteresis losses that are induced by the alternating magnetic field, depending on the magnetic and electric properties of the susceptor materials of the susceptor arrangement 1. The susceptor arrangement 1 is heated until reaching an operating temperature sufficient to vaporize the aerosol-forming substrate 18 surrounding the susceptor arrangement 1 within the aerosol generating article 10. Within a distal portion 28, the aerosol-generating device 23 further comprises a DC power supply 29 and a controller 30 (only schematically illustrated in FIG. 6) for powering and controlling the heating process. Apart from the induction coil 27, the inductive heating arrangement preferably is at least partially integral part of the controller 30.

FIG. 7 shows an aerosol-generating device 23′ comprising a susceptor arrangement 1 according to the present invention. The aerosol-generating device 23′ is configured for use with an aerosol-generating article 10′. The aerosol-generating article 10′ is configured substantially similar to the aerosol-generating article 10 shown in FIG. 5, but lacks the susceptor arrangement 1. Together, the aerosol-generating device 23′ and the aerosol-generating article 10′ form an aerosol-generating system 24′. The aerosol-generating device 23′ comprises a cylindrical receiving cavity 25′ defined within a proximal portion 26′ of the aerosol-generating device 23′ for receiving a least a distal portion of the aerosol-generating article 10′ therein. The aerosol-generating device 23′ further comprises an inductive heating arrangement including an induction coil 27′ for generating an alternating, in particular high-frequency magnetic field within the cylindrical receiving cavity 25′. The induction coil 27′ is a helical coil circumferentially surrounding the cylindrical receiving cavity 25′. The susceptor arrangement 1 is provided as a substantially cylindrical hollow body within the and coaxial to the cylindrical receiving cavity 25′. In this configuration, the susceptor arrangement 1 realizes an inductive heating oven or heating chamber. The susceptor arrangement 1 is arranged such that it surrounds at least partially the substrate element 12 of the aerosol-generating article 10′ when the aerosol-generating article 10′ is inserted in the cylindrical receiving cavity 25′, as shown in FIG. 7.

The susceptor arrangement 1 is further arranged such that it is exposed to a magnetic field generated by the inductive heating arrangement of the aerosol-generating device 23′. Thus, when activating the inductive heating arrangement, the susceptor arrangement 1 heats up due to eddy currents and/or hysteresis losses that are induced by the alternating magnetic field, depending on the magnetic and electric properties of the susceptor materials of the susceptor arrangement 1. The susceptor arrangement 1 is heated until reaching an operating temperature sufficient to vaporize the aerosol-forming substrate 18 within the aerosol generating article 10′. Within a distal portion 28′, the aerosol-generating device 23′ further comprises a DC power supply 29′ and a controller 30′ (only schematically illustrated in FIG. 7) for powering and controlling the heating process. Apart from the induction coil 27′, the inductive heating arrangement preferably is at least partially integral part of the controller 30′.

FIG. 8 shows another embodiment of an aerosol-generating device 23″ comprising a susceptor arrangement 1 according to the present invention. The aerosol-generating device 23″ is configured for use with an aerosol-generating article 10″. The aerosol-generating article 10″ is configured substantially similar to the aerosol-generating article 10 shown in FIG. 5, but lacks the susceptor arrangement 1 and the distal front plug element 11. Instead, the substrate element 12 has larger length extension.

The aerosol-generating device 23″ comprises a cylindrical receiving cavity 25″ defined within a proximal portion 26″ of the aerosol-generating device 23″ for receiving a least a distal portion of the aerosol-generating article 10″ therein. The aerosol-generating device 23″ further comprises an inductive heating arrangement including an induction coil 27″ for generating an alternating, in particular high-frequency magnetic field within the cylindrical receiving cavity 25″. The induction coil 27″ is a helical coil circumferentially surrounding the cylindrical receiving cavity 25″. The susceptor arrangement 1 is provided as a blade element, rod element or pin element and is arranged within the cylindrical receiving cavity 25″

A distal end of the susceptor arrangement 1 is arranged a bottom portion of the cylindrical receiving cavity 25″. From there, the susceptor arrangement 1 extends into the inner void of the cylindrical receiving cavity 25″ towards and opening of the cylindrical receiving cavity 25″ located at the proximal portion 26″ of the aerosol-generating device 23″. A proximal end of the susceptor arrangement 1 may be tapered, pointed or provided with a sharp edge to easily penetrate into the substrate element 12 of the aerosol-generating article 10″ at the distal end 16 of the aerosol-generating article 10″ when the aerosol-generating article 10″ is inserted in the cylindrical receiving cavity 25″, as shown in FIG. 8.

The susceptor arrangement 1 is arranged such that it is exposed to a magnetic field generated by the inductive heating arrangement of the aerosol-generating device 23″. Thus, when activating the inductive heating arrangement, the susceptor arrangement 1 heats up due to eddy currents and/or hysteresis losses that are induced by the alternating magnetic field, depending on the magnetic and electric properties of the susceptor materials of the susceptor arrangement 1. The susceptor arrangement 1 is heated until reaching an operating temperature sufficient to vaporize the aerosol-forming substrate 18 within the aerosol generating article 10″. Within a distal portion 28″, the aerosol-generating device 23″ further comprises a DC power supply 29″ and a controller 30″ (only schematically illustrated in FIG. 8) for powering and controlling the heating process. Apart from the induction coil 27″, the inductive heating arrangement preferably is at least partially integral part of the controller 30″.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-27. (canceled)

28. A susceptor arrangement for inductively heating an aerosol-forming substrate, the susceptor arrangement comprising:
at least one susceptor body with a susceptor body surface, the at least one susceptor body comprising a first susceptor material; and
a first heat-spreading layer comprising a first heat-spreading material,
wherein the first heat-spreading layer extends across at least a portion of the susceptor body surface in thermal contact with or in thermal proximity to the portion of the susceptor body surface, and
wherein the first heat-spreading material is a non-magnetic metal or a non-magnetic metal alloy that has a thermal conductivity greater than a thermal conductivity of the first susceptor material by at least a factor of 3.5.

29. The susceptor arrangement according to claim 28, wherein the non-magnetic metal or a non-magnetic metal alloy is selected from a group comprising copper, a copper alloy, aluminum, and an aluminum alloy.

30. The susceptor arrangement according to claim 28, wherein the first heat-spreading layer has a thickness of 2 micrometers to 100 micrometers.

31. The susceptor arrangement according to claim 28, wherein a separator layer is arranged between the at least one susceptor body and the first heat-spreading layer.

32. The susceptor arrangement according to claim 31, wherein the separator layer comprises at least one of an electrical insulation layer, an anti-diffusion layer, a temperature marker layer with a specific Curie temperature, and a protective layer.

33. The susceptor arrangement according to claim 28, wherein the susceptor body is a substantially flat element and the susceptor body surface comprises a first susceptor body main surface and an opposite second susceptor body main surface.

34. The susceptor arrangement according to claim 33,
further comprising a second heat-spreading layer comprising a second heat-spreading material,
wherein the first heat-spreading layer extends across at least a portion of the first susceptor body main surface, and
wherein the second heat-spreading layer extends across at least a portion of the second susceptor body main surface in thermal contact with or in thermal proximity to the portion of the second susceptor body main surface.

35. The susceptor arrangement according to claim 34, wherein the first heat spreading layer extends across the whole first susceptor body main surface and/or the second heat spreading layer extends across the whole second susceptor body main surface.

36. The susceptor arrangement according to claim 33, wherein the at least one susceptor body is a multi-layer susceptor body.

37. A susceptor arrangement for inductively heating an aerosol-forming substrate, the susceptor arrangement comprising:
at least one susceptor body with a susceptor body surface, wherein the at least one susceptor body is a substantially flat element and the susceptor body surface comprises a first susceptor body main surface and an opposite second susceptor body main surface, the at least one susceptor body comprising a first susceptor material; and
a first heat-spreading layer comprising a first heat-spreading material,
wherein the first heat-spreading layer extends across at least a portion of the susceptor body surface in thermal contact with or in thermal proximity to the portion of the susceptor body surface,
wherein the first heat-spreading material is a metal that has a thermal conductivity greater than the thermal conductivity of the first susceptor material by at least a factor of 3.5, and
wherein the first heat-spreading layer is at least partially coated with a temperature marker layer with a specific Curie temperature.

38. The susceptor arrangement according to claim 37, wherein the metal is selected from a group comprising copper, a copper alloy, nickel, a nickel alloy, aluminum, and an aluminum alloy.

39. The susceptor arrangement according to claim 37, wherein the first heat-spreading layer has with a thickness of 2 micrometers to 100 micrometers.

40. The susceptor arrangement according to claim 37, wherein a separator layer is arranged between the at least one susceptor body and the first heat-spreading layer.

41. The susceptor arrangement according to claim 37,
further comprising a second heat-spreading layer comprising a second heat-spreading material,
wherein the first heat-spreading layer extends across at least a portion of the first susceptor body main surface, and
wherein the second heat-spreading layer extends across at least a portion of the second susceptor body main surface in thermal contact with or in thermal proximity to the portion of the second susceptor body main surface.

42. The susceptor arrangement according to claim 41, wherein the first heat spreading layer extends across the whole first susceptor body main surface and/or the second heat spreading layer extends across the whole second susceptor body main surface.

43. The susceptor arrangement according to claim 37, wherein the at least one susceptor body is a multi-layer susceptor body.

44. A susceptor arrangement for inductively heating an aerosol-forming substrate, the susceptor arrangement comprising:
at least one susceptor body with a susceptor body surface, the at least one susceptor body comprising a first susceptor material; and
a first heat-spreading layer comprising a first heat-spreading material,
wherein the first heat-spreading layer extends across at least a portion of the susceptor body surface in thermal contact with or in thermal proximity to the portion of the susceptor body surface,
wherein the first heat-spreading material has a thermal conductivity greater than a thermal conductivity of the first susceptor material by at least a factor of 3.5, and
wherein the first heat-spreading material is a carbon allotrope.

45. The susceptor arrangement according to claim 44, wherein the first heat-spreading material is provided as a graphite sheet.

46. The susceptor arrangement according to claim 45, wherein the graphite sheet has a thickness of 1 micrometer to 200 micrometers.

47. The susceptor arrangement according to claim 44, wherein a separator layer is arranged between the at least one susceptor body and the first heat-spreading layer.

48. The susceptor arrangement according to claim 47, wherein the separator layer comprises at least one of an electrical insulation layer, an anti-diffusion layer, a temperature marker layer with a specific Curie temperature, and a protective layer.

49. The susceptor arrangement according to claim 44, wherein the at least one susceptor body is a substantially flat element and the susceptor body surface comprises a first susceptor body main surface and an opposite second susceptor body main surface.

50. The susceptor arrangement according to claim 49,
further comprising a second heat-spreading layer comprising a second heat-spreading material,
wherein the first heat-spreading layer extends across at least a portion of the first susceptor body main surface, and
wherein the second heat-spreading layer extends across at least a portion of the second susceptor body main surface in thermal contact with or in thermal proximity to the portion of the second susceptor body main surface.

51. The susceptor arrangement according to claim 50, wherein the first heat spreading layer extends across the whole first susceptor body main surface and/or the second heat spreading layer extends across the whole second susceptor body main surface.

52. The susceptor arrangement according to claim 49, wherein the at least one susceptor body is a multi-layer susceptor body.

53. The susceptor arrangement according to claim 34, wherein the first and/or the second heat-spreading material has a thermal conductivity greater than 80 W/(m K).

54. An inductively heatable aerosol-generating article comprising an aerosol-forming substrate and at least one susceptor arrangement according to claim 28.
